(19) United States
(12) Patent Application Publication
(10) Pub. No.: US 2007/0150568 A1
(43) Pub. Date: Jun. 28, 2007

(54) Non-destructive synthetic transaction configuration

(76) Inventor: Jon Ruiz, Eagan, MN (US)

Correspondence Address: VIERRA MAGEN MARCUS & DENIRO LLP, 575 MARKET STREET SUITE 2500, SAN FRANCISCO, CA, 94105, US

(21) Appl. No.: 11/319,706

(22) Filed: Dec. 28, 2005

(51) Int. Cl. G06F 15/173

(52) U.S. Cl. 709/223

(57) ABSTRACT

Non-corrupting synthetic transactions are generated for testing a web service. The transactions do not corrupt data for a front end web server of the web service or a back end application server accessed by the web server. The synthetic transactions may be generated using code inserted into an application and a network traffic interceptor which intercepts traffic for a web service associated with the application. The synthetic transactions may also be generated by intercepting live traffic for the web server and monitoring application server behavior. The intercepted traffic and data associated with the monitored behavior data are processed. Transactions are then identified which would not corrupt data if used as a synthetic transaction. Transactions are identified by comparing the intercepted traffic data and monitored behavior data. The synthetic transactions are then transmitted to the web server when needed.

### BACKGROUND

Synthetic transaction generators are important tools for testing the functionality and reliability of web services. Typically, a synthetic transaction generator sends requests and other transaction data to a web service. The web service receives and processes the synthetic requests. An administrator may monitor the performance of the web server while processing the synthetic requests. This allows an administrator to determine the performance of the web server while processing a set of known synthetic requests.

Synthetic transaction generators are useful for quality assurance (QA) testing and production testing. In QA testing, synthetic transaction generators are used to test functionality and measure the performance of an application server under a load. Transaction generators used in production generate synthetic traffic and monitor how the receiving web server operates. For example, the web service may be monitored to determine if it is running slow or fast or whether it is available or not.

Some previous synthetic transaction generators used in production testing are manually configured to provide requests to a particular uniform resource locator (URL) address. Manually generating requests to URL addresses to test a web service requires significant time and resources. The time and resources required to manually configure synthetic transaction generators makes this method undesirable.

Other synthetic transaction generators used during production record live user traffic rather then require transactions to be manually configured. The recorded traffic is then transmitted to the web service. In this case, the generators create script from the recorded traffic. The script reproduces the live traffic and is executed to provide synthetic transactions to the web service.

Synthetic transaction generators which replay previously recorded live traffic have disadvantages. For instance, live traffic for an e-commerce web service typically involves purchasing products or other transactions that change data at an application server or a backend server. The replayed traffic for these transactions would also change data at the application server or the backend server. This may cause data corruptions and other complications for a business which provides the web service. For example, if recorded traffic is replayed several times which includes transactions for purchasing a product from a web service, the product will effectively be purchased several times during replay of the transactions. This will create unwanted invoices, inventory adjustments and other complications for the business associated with the web service.

### SUMMARY

The present technology, roughly described, pertains to generating synthetic transactions which do not corrupt data associated with a web service provided by a web server and an associated application server. The synthetic transactions are generated from live user traffic which is intercepted. The intercepted traffic is processed to identify traffic which would be appropriate as synthetic transactions. In one embodiment, sets of ordered synthetic transactions within the intercepted traffic are identified as suitable synthetic transactions. The synthetic transactions are then transmitted to the web service.

Live traffic may be suitable as synthetic transactions if the live traffic does not corrupt data as a synthetic transaction. In some cases, a request received by a web server requires the web server to send a request to an application server. In one embodiment, a synthetic transaction corrupts data if it causes data to be written or changed at an application server or backend server or otherwise changes the state of the application server. Live traffic (e.g., requests received by a web server) that does not result in a write or change to data at an application server or backend server or change the state of an application server may be used as synthetic transactions.

To determine if live traffic would corrupt data as a synthetic transaction, the live traffic is monitored and processed. Live traffic can be monitored in more than one place for a web service. For instance, live traffic can be intercepted before it is received by a web server. In this case, a tap device or other machine located before a web server on the network may be used to intercept all traffic sent to and from the web server. The intercepted traffic is reported to a processing module and then forwarded to the appropriate destination.

An application server can also be monitored. In one embodiment, monitoring code is inserted into the application server. The monitoring code intercepts calls to application server objects and functions. When the objects and functions are executed in response to requests from the web server, the calls are first reported to a processing module. After reporting the requests, the monitoring code executes the requests. A processing module receives the reported transaction data from the tap device and the code within the application server. The processing module then identifies transactions which would be suitable as synthetic transactions. A set of non-corrupting synthetic transactions is provided to a synthetic transaction generator, which sends the transactions to the web service when needed.

In one embodiment, synthetic transactions are constructed from network traffic information associated with a web service and behavior data associated with an application. The web service may include or have access to the application to provide a service over a network. The network traffic information is intercepted by an interceptor device and provided to a processing module. The behavior data is indicative of the performance of the application.

In another embodiment, synthetic transactions can be created from data corruption information. The data corruption information can be identified using monitoring code at an application and a web server traffic interceptor. In some cases, the monitoring code may be inserted into the application to retrieve application behavior data. The resulting synthetic transactions can then be provided to a web server.

This summary is provided to introduce a selection of concepts in a simplified form that are further described below in the description. This summary is not intended to identify key features or essential features of the claimed subject matter, nor is it intended to be used as an identifier in determining the scope of the claimed subject matter.

### BRIEF DESCRIPTION OF THE DRAWINGS

FIG. 1 is an embodiment of a block diagram illustrating how byte code for an application is instrumented.

FIG. 2 is a block diagram of a system for monitoring an application.

FIG. 3 is a block diagram of an embodiment of a system for generating synthetic transactions.

FIG. 4 is a block diagram of an embodiment of a computing system for implementing the present technology.

FIG. 5 is a flowchart of an embodiment of a process for providing synthetic transactions to a web service.

FIG. 6 is a flowchart of an embodiment of a process for receiving user requests sent to a web service.

FIG. 7 is a flowchart of an embodiment of a process for processing a request by a web server.

FIG. 8 is a flowchart of an embodiment of a process for processing a request by a monitored application.

FIGS. 9A and 9B are flowcharts of an embodiment of a process for identifying user requests which would not corrupt data as synthetic transactions.

FIG. 10 is a flowchart of an embodiment of a process for generating synthetic transaction information.

FIG. 11 is a flowchart of an embodiment of a process for providing synthetic transactions to a web service.

### DETAILED DESCRIPTION

Non-corrupting synthetic transactions are generated for a web service. The transactions do not corrupt data for a front end web server of the web service or a back end application server accessed by the web server. The synthetic transactions are generated by intercepting live traffic for the web server and monitoring application server behavior. Transactions are then identified which would not corrupt data if used as a synthetic transaction. The synthetic transactions are then transmitted to the web server when needed.

In one embodiment, a web server request will corrupt data as a synthetic transaction if it writes or changes data at an application server or otherwise changes the state of the application server. Though the live request may change or write data or change the application server state as part of a legitimate transaction for a user, synthetic transactions should not make these changes to the application server. Thus, transactions which would corrupt data are not included in a set of synthetic transactions to be sent to a web server.

The technology discussed herein involves monitoring a web server and application server to identify traffic which does not corrupt data. In one embodiment, live traffic sent to and from a web server is intercepted. The intercepted traffic is processed to determine web service request data and forwarded to the web server. The web server request data is forwarded to a processing module, or Enterprise Manager. The web server receives and processes the request. In some cases, the web server generates a request for an application server in response to the received request. The application server processes the received request. The application server behavior data associated with the processed request is monitored and reported to the processing module. The processing module receives and processes the web server request data and application server behavior data. Processing the data includes identifying traffic (e.g., live user requests received by web server 340) that would not corrupt data as a synthetic transaction. The identified traffic is configured into synthetic transaction information and sent to a synthetic transaction generator. The synthetic transaction generator sends the synthetic transactions to the web server.

An application server can be monitored using performance monitoring code. In one embodiment, the monitoring code is inserted into the application server. The monitoring code intercepts calls to application server objects and functions. The intercepted calls include those made by the web server to a managed application located on the application server. When the objects and functions are called, the monitoring code reports the calls to the processing module. After reporting the calls, the monitoring code allows the requests to be executed.

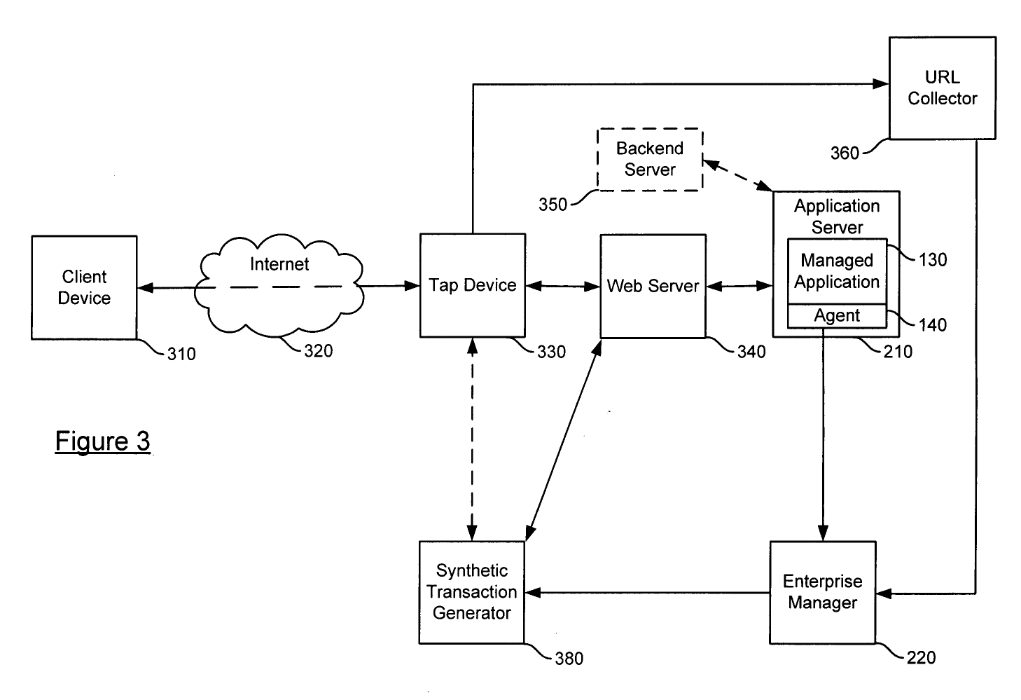

The processing module receives reported transaction data as data streams from a tap device and the monitoring code within the application server. The data streams may include a continuous steam of data elements (including data, control commands, and other information) sent over a communication line between the processing module and appropriate device (e.g., the tap device or the application server). The tap device may be a device which intercepts traffic (e.g., network traffic) for a web service. A tap device is discussed in more detail below with respect to FIG. 3. Transactions are then identified which would be suitable as synthetic transactions. Identification of potential synthetic transactions by the processing module includes analyzing the data streams separately as well as comparing data from the data streams to each other. Non-corrupting synthetic transaction information is then generated and provided to a synthetic transaction generator. The synthetic transaction generator then sends synthetic transactions to the web service.

Synthetic transactions can be generated in several ways. In one embodiment, synthetic transactions can be constructed from network traffic information associated with a web service and behavior data associated with an application. The web service may include or have access to the application to provide a service over a network. The network traffic information is intercepted by an interceptor device and provided to a processing module. The behavior data is indicative of the performance of the application. In another embodiment, synthetic transactions can be created from data corruption information. The data corruption information can be identified using monitoring code at an application and a web server traffic interceptor. In some cases, the monitoring code may be inserted into the application to retrieve application behavior data. The resulting synthetic transactions can then be provided to a web server. These and other methods for generating synthetic transactions are discussed in more detail below.

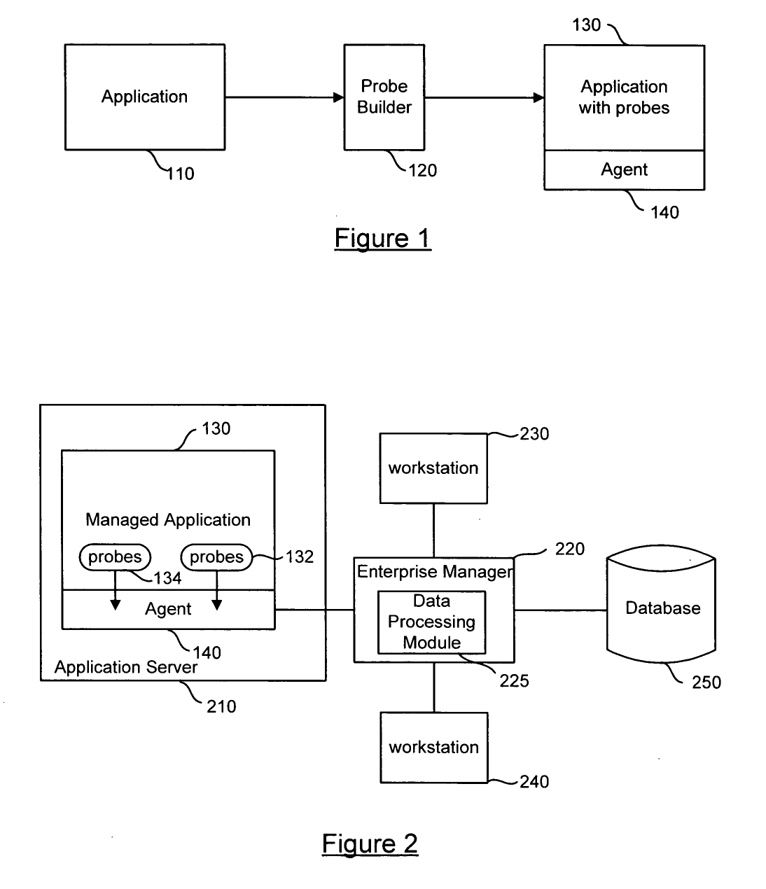

In one embodiment, the technology herein can be used to monitor behavior of an application on an application server using bytecode instrumentation. The technology herein may also be used to access information from the particular application. To monitor the application, an application management tool may instrument the application's object code (also called bytecode). FIG. 1 depicts an exemplar process for modifying an application's bytecode. FIG. 1 shows Application 110, Probe Builder 120, Application 130 with probes and Agent 140. Application 130 includes probes used to access information from the application, and application 110 is the application before the probes are added. Application 110 can be a Java application or a different type of application.

Probe Builder 120 instruments (e.g. modifies) the bytecode for Application 110 to add probes and additional code to Application 110 in order to create Application 130. The probes may measure specific pieces of information about the application without changing the application's business logic. Probe Builder 120 also generates Agent 140. Agent 140 may be installed on the same machine as Application 130 or a separate machine. Once the probes have been installed in the application bytecode, the application is referred to as a managed application. More information about instrumenting byte code can be found in U.S. Pat. No. 6,260,187 “System For Modifying Object Oriented Code” by Lewis K. Cirne, incorporated herein by reference in its entirety.

In one embodiment, the technology described herein doesn't actually modify source code. Rather, the present invention modifies object code. The object code is modified conceptually in the same manner that source code modifications are made. More information about such object code modification can be found in U.S. patent application Ser. No. 09/795,901, “Adding Functionality To Existing Code At Exits,” filed on Feb. 28, 2001, incorporated herein by reference in its entirety.

FIG. 2 is a conceptual view of the components of the application performance management tool. In addition to managed Application 140 with probes 132 and 134, FIG. 2 also depicts Enterprise Manager 220, database 250, workstation 230 and workstation 240. As a managed application runs, probes (e.g. 132 and/or 134) relay data to Agent 140. In one embodiment, probes 132 and 134 may be implemented in objects and other code that write data, change data or otherwise cause the state of an application server to change. Agent 140 then collects, summarizes and sends the data to Enterprise Manager 120.

Enterprise Manager 120 receives performance data from managed applications via Agent 140, runs requested calculations, makes performance data available to workstations 230-240 and optionally sends performance data to database 250 for later analysis. The workstations (e.g. 124 and 126) are the graphical user interface for viewing performance data. The workstations are used to create custom views of performance data which can be monitored by a human operator. In one embodiment, the workstations consist of two main windows: a console and an explorer. The console displays performance data in a set of customizable views. The explorer depicts alerts and calculators that filter performance data so that the data can be viewed in a meaningful way. The elements of the workstation that organize, manipulate, filter and display performance data include actions, alerts, calculators, dashboards, persistent collections, metric groupings, comparisons, smart triggers and SNMP collections. In one embodiment, workstations 230-240 and database 250 are not used or needed to generate synthetic transactions.

In one embodiment of the system of FIG. 2, each of the components is running on different machines. That is, workstation 230 is on a first computing device, workstation 240 is on a second computing device, Enterprise Manager 220 is on a third computing device, and Managed Application 130 is running on a fourth computing device. In another embodiment, two or more (or all) of the components are operating on the same computing device. For example, Managed Application 130 and Agent 140 may be on a first computing device, Enterprise Manager 220 on a second computing device and a workstation on a third computing device. Alternatively, all of the components of FIG. 2 can run on the same computing device. Any or all of these computing devices can be any of various different types of computing devices, including personal computers, minicomputers, mainframes, servers, handheld computing devices, mobile computing devices, etc. Typically, these computing devices will include one or more processors in communication with one or more processor readable storage devices, communication interfaces, peripheral devices, etc. Examples of the storage devices include RAM, ROM, hard disk drives, floppy disk drives, CD ROMS, DVDs, flash memory, etc. Examples of peripherals include printers, monitors, keyboards, pointing devices, etc. Examples of communication interfaces include network cards, modems, wireless transmitters/receivers, etc. The system running the managed application can include a web server/application server. The system running the managed application may also be part of a network, including a LAN, a WAN, the Internet, etc. In some embodiments, all or part of the invention is implemented in software that is stored on one or more processor readable storage devices and is used to program one or more processors.

FIG. 3 is a block diagram of an embodiment of a system for generating synthetic transactions. The system of FIG. 3 includes a client device 310, Internet 320, tap device 330, web server 340, application server 210, URL collector 360, Enterprise Manager 220, backend server 350 and synthetic transaction generator 380. Application server 210 includes managed application 130 and agent 140. In one embodiment, application server 210, managed application 130, agent 140 and Enterprise Manager 220 are the same as those in FIGS. 1 and 2 discussed above.

Client device 310 generates real traffic for web server 340 over Internet 320. In one embodiment, client device 310 may initiate a request to be sent to web server 340 through a browser application residing on the device. In response to a request received from client device 310, web service 340 provides a response to a user at a client device. Though only client device user is illustrated in FIG. 3, web server 340 may receive and process real traffic from multiple client devices.

Tap device 330 may be implemented with any network tap or mirrored port hardware, software or combination thereof. In one embodiment, tap device 330 may be implemented using hardware from the Cisco MDS 9000 Family of Multilayer Directors and Fabric Switch, by Cisco Systems, Inc., of San Jose, Calif. In operation, tap device 330 intercepts traffic sent to and from web server 340 from client device 310. The intercepted traffic is provided to URL collector 360. In one embodiment, tap device 330 intercepts all TCP/IP traffic at the protocol level. The TCP/IP traffic is then forwarded to URL collector 360. After intercepting traffic and forwarding a copy of the traffic to URL collector 360, the traffic is sent to its intended destination. For example, a request sent by client device 310 to web server 340 is intercepted by tap device 330. Tap device 330 forwards a copy of the request to URL collector 360 and then forwards the actual request to web server 340. In some embodiments, tap device 330 may also intercept synthetic traffic sent to web server 340 from synthetic transaction generator 380. Interception of synthetic transactions by tap device 330 is optional as indicated by the dashed line between synthetic transaction generator 380 and tap device 330.

URL collector 360 receives web server traffic data from tap device 330. In particular, URL collector 360 can receive a TCP/IP data stream from tap device 330. In response to receiving the data stream from tap device 330, URL collector 360 builds an http request from the data stream. Once the http request is built, URL collector 360 determines the URL and transaction identifier associated with the request. The URL collector 360 then forwards the URL and transaction identifier to Enterprise Manager 220. In some embodiments, the transaction identifier for an http request is determined from a response associated with the request. This is discussed in more detail below. In one embodiment, URL collector 360 may also retrieve a session identifier from the request. In one embodiment, a session identifier is a unique identifier associated with a set of transactions performed while a user is logged into a web service, a set of transactions between a user and a particular web server, or some other set of transactions associated with a user. Once retrieved, the session identifier is also forwarded to Enterprise Manager 220. In some embodiments, URL collector 360 may provide information to Enterprise Manager 220 as to whether the current message is associated with a request or a response. In other embodiments, URL Collector 360 only forwards data associated with web server requests to Enterprise Manager 220. More information about a URL collector can be found in United States patent publication number 2003/0191989, titled, “Methods, systems and computer program products for triggered data collection and correlation of status and/or state in distributed data processing systems,” having inventor Patrick O'Sullivan and incorporated herein by reference in its entirety.

Web server 340 provides a web service over Internet 320. The web service may be an e-commerce web service or some other type of web service. Web server 340 may receive requests from client device 310. In one embodiment, a request to web server 340 may require web server 340 to call application server 210. For example, a request to web server 340 may initiate a servlet call via HTTP or an EJB call (or a JDBC call) by the application server to backend server 350. Any of the calls may write data to the application server. For example, the JDBC call may include a commit statement or scene other statement which changes data in managed application 130 or backend server 350. In response to sending a request to application server 210, web server 340 will receive a response from application server 210. Web server 340 processes the response and forwards a response to client device 310.

Application server 210 may communicate with web server 340 and Enterprise Manager 220. Application server 210 includes managed application 130 and agent 140. Probe builder 120 inserts code in the form of probes within managed application 130. The code may be monitoring code, destructive transaction detection code or other code. In one embodiment, the performance monitoring code includes code that detects destructive transactions. The probes are placed to intercept calls made to managed application 130 which change data, write data or otherwise change the state of managed application 130. The probes report the calls to Agent 140 on application server 210. Agent 140 then reports application server behavior data to Enterprise Manager 220. The calls are then executed as normal. For example, the probes may be inserted into objects which perform data write and data change functions in J2EE and JDBC protocols. Operation of agent 140 is discussed in more detail below.

Backend server 350 may communicate with application server 210. As indicated by the dashed line comprising backend server 350 in FIG. 3, backend server 350 is optional. Backend server 350 may be implemented as a database server, a framework server, a server providing some type of resource to application server 210, or some other type of server. In one embodiment, backend server 350 may store data. In this case, when a web service request initiates data stored in backend server 350 to be changed, the request is considered destructive.

Enterprise Manager 220 receives transaction data from URL collector 360 and agent 140 on application server 210 and provides synthetic transaction information to synthetic transaction generator 380. In particular, Enterprise Manager 220 receives a data stream from URL collector 360 having a transaction identifier and URL information for transactions received by web server 340. In one embodiment, each transaction received by web server 340 is associated with unique transaction identification information. The transaction identifier may be included as part of the transaction, derived from the transaction data within the transaction, assigned by tap device 330 or determined in some other manner.

In some embodiments, the unique transaction identifier may be determined from a response generated by the web service or web application comprising web server 340, application server 210 and backend server 350. In this case, a unique transaction identifier may be assigned to a transaction request by web server 340, application server 210, or managed application 130 on application server 210. The unique transaction identifier is inserted into the response generated in response to the request. The request is sent from web server 340 to the requesting entity, such as client device 310. Tap device 330 intercepts the response, retrieves the unique transaction identifier and determines the corresponding request. Tap device 330 then associates the unique transaction identifier with the URL associated with the request.

The URL information includes the URL address to which the transaction is directed. For example, for requests by client device 310 to web server 340, the URL information will include the URL address of the web server to which the request is sent and http fields relevant to the transaction (e.g., http headers, cookies and http form fields). In one embodiment, the headers, cookies and other data to include can be specific to the application server and may be configurable. These configurations may include including common configurations (ones for known application servers) in the product and other configurations.

A data stream is also received by Enterprise Manager 220 from Agent 140 of application server 210. The data stream received from Agent 140 includes a transaction identifier and corruption information for transactions processed by managed application 130. The transaction identifier identifies transactions received by web server 340 and processed by application server 210, and will match a transaction identifier received by Enterprise Manager from URL Collector 360. The data streams from both URL Collector 360 and Agent 140 are processed to determine ordered transactions that would not corrupt data as synthetic transactions. This is discussed in more detail below. After identifying the appropriate transactions, synthetic transaction information is forwarded to synthetic transaction generator 380.

Synthetic transaction generator 380 receives synthetic transaction information from Enterprise Manger 220. After receiving the information, the generator configures the information into a set of ordered transactions. In one embodiment, configuring the information may include formatting the information into one or more requests for a web server to test. The requests may be ordered and include parameters received as part of the synthetic transaction information. In one embodiment, the http parameters and the ordering is determined by URL collector 360 based on the parameters seen and order that it sees requests for a specific session. In this case, Synthetic transaction generator 380 transmits transactions in the order determined by URL Collector 360.

Synthetic transaction generator 380 sends sets of ordered transactions to the web service comprised of web server 340, application server 210 and backend server 250. In one embodiment, the synthetic transactions can be injected into the system at any number of locations including before web server 340, before tap device 330, at client 310 in the Internet or at any other device that lies between client 310 and web server 340. For purposes of discussion, synthetic transactions inserted to web server 340 will be discussed herein. This is discussed in more detail below with respect to FIG. 11. In some embodiments, tap device 330 may intercept the ordered synthetic transactions, as indicated by the dashed line in FIG. 3. Synthetic transaction generator 380 can be implemented by several any of several synthetic transaction generator products. For example, synthetic transaction generator 380 may be implemented by “JMeter” software, provided by The Apache Software Foundation of Forest Hill, Md., “Load Runner” software by Mercury Interactive Corporation of Mountain View, Calif., and “Site Scope” software, also provided by Mercury Interactive Corporation.

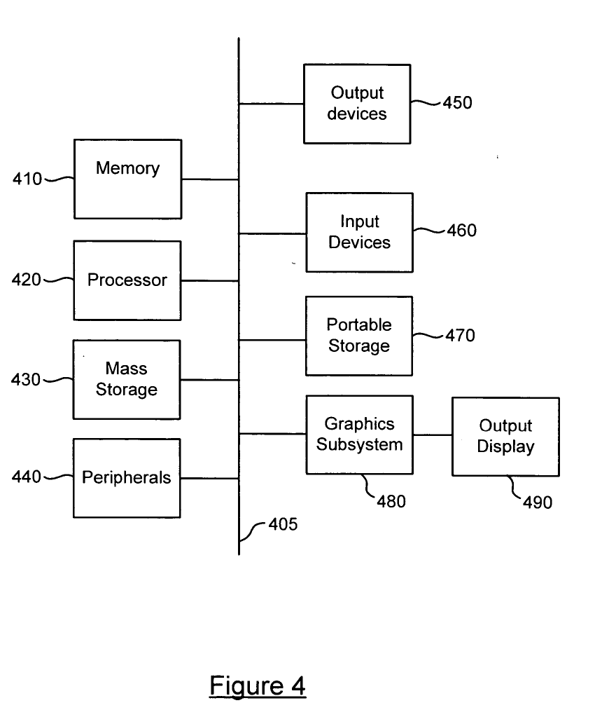

FIG. 4 illustrates an embodiment of a computing system for use with the present technology. In one embodiment, the system of FIG. 4 may be used to implement work stations 230-240 and database 250 of FIG. 2 and web server 310, application server 210, URL Collector 360, Enterprise Manager 220, synthetic transaction generator 380, work stations 230-240, database 250 and client device 310 may communicate with tap device 330 in FIG. 3.

The computer system of FIG. 4 includes one or more processors 420 and main memory 410. Main memory 410 stores, in part, instructions and data for execution by processor unit 420. If the system of the present invention is wholly or partially implemented in software, main memory 410 can store the executable code when in operation. The system of FIG. 4 further includes a mass storage device 430, peripheral device(s) 440, user input device(s) 460, output devices 450, portable storage medium drive(s) 470, a graphics subsystem 480 and an output display 490. For purposes of simplicity, the components shown in FIG. 4 are depicted as being connected via a single bus 405. However, the components may be connected through one or more data transport means. For example, processor unit 420 and main memory 410 may be connected via a local microprocessor bus, and the mass storage device 430, peripheral device(s) 440, portable storage medium drive(s) 470, and graphics subsystem 64 may be connected via one or more input/output (I/O) buses. Mass storage device 430, which may be implemented with a magnetic disk drive or an optical disk drive, is a non-volatile storage device for storing data and instructions for use by processor unit 420. In one embodiment, mass storage device 430 stores the system software for implementing the present invention for purposes of loading to main memory 410.

Portable storage medium drive 470 operates in conjunction with a portable non-volatile storage medium, such as a floppy disk, to input and output data and code to and from the computer system of FIG. 4. In one embodiment, the system software for implementing the present invention is stored on such a portable medium, and is input to the computer system via the portable storage medium drive 470. Peripheral device(s) 440 may include any type of computer support device, such as an input/output (I/O) interface, to add additional functionality to the computer system. For example, peripheral device(s) 440 may include a network interface for connecting the computer system to a network, a modem, a router, etc.

User input device(s) 460 provides a portion of a user interface. User input device(s) 460 may include an alpha-numeric keypad for inputting alpha-numeric and other information, or a pointing device, such as a mouse, a trackball, stylus, or cursor direction keys. In order to display textual and graphical information, the computer system of FIG. 4 includes graphics subsystem 480 and output display 490. Output display 490 may include a cathode ray tube (CRT) display, liquid crystal display (LCD) or other suitable display device. Graphics subsystem 480 receives textual and graphical information, and processes the information for output to display 490. Additionally, the system of FIG. 4 includes output devices 450. Examples of suitable output devices include speakers, printers, network interfaces, monitors, etc.

The components contained in the computer system of FIG. 4 are those typically found in computer systems suitable for use with the present invention, and are intended to represent a broad category of such computer components that are well known in the art. Thus, the computer system of FIG. 4 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

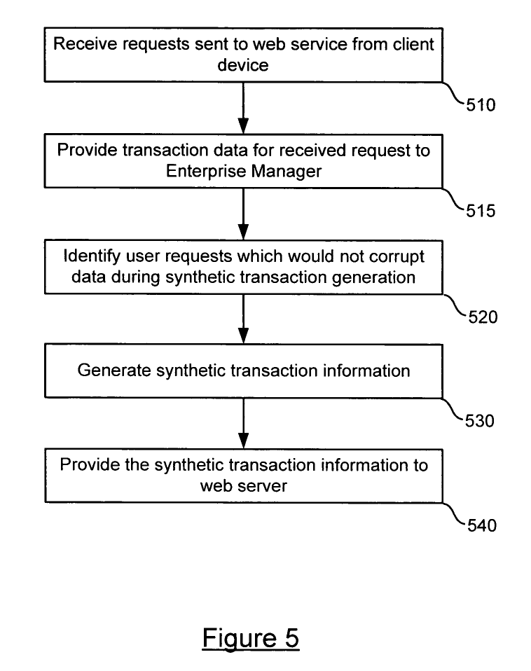

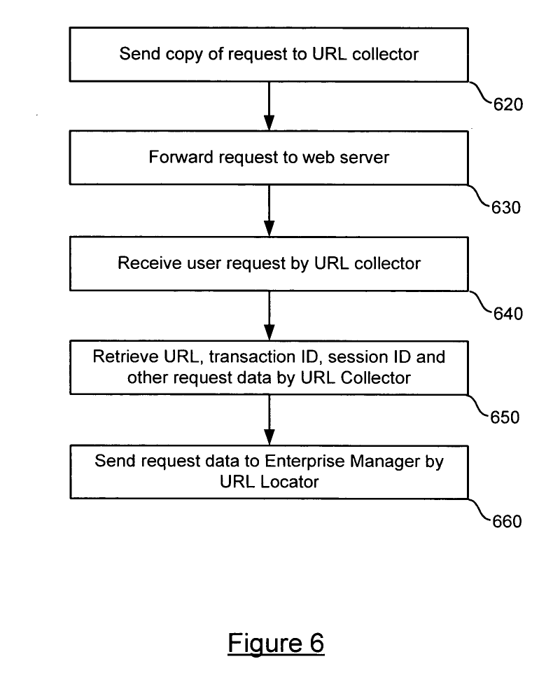

FIG. 5 is a flowchart of an embodiment of a process for providing synthetic transactions to a web service. FIG. 5 provides a high-level description of a process performed by the present technology. First, user requests sent to a web service are received at step 510. The user requests are received by tap device 330. The received user requests are forwarded to web server 340 and URL collector 360. Transaction data for the received requests is then provided to Enterprise Manager 220 at step 515. In one embodiment, the transaction data is provided by both URL collector 360 and Agent 140 on application server 210. This is discussed in more detail below with respect to FIGS. 6-8.

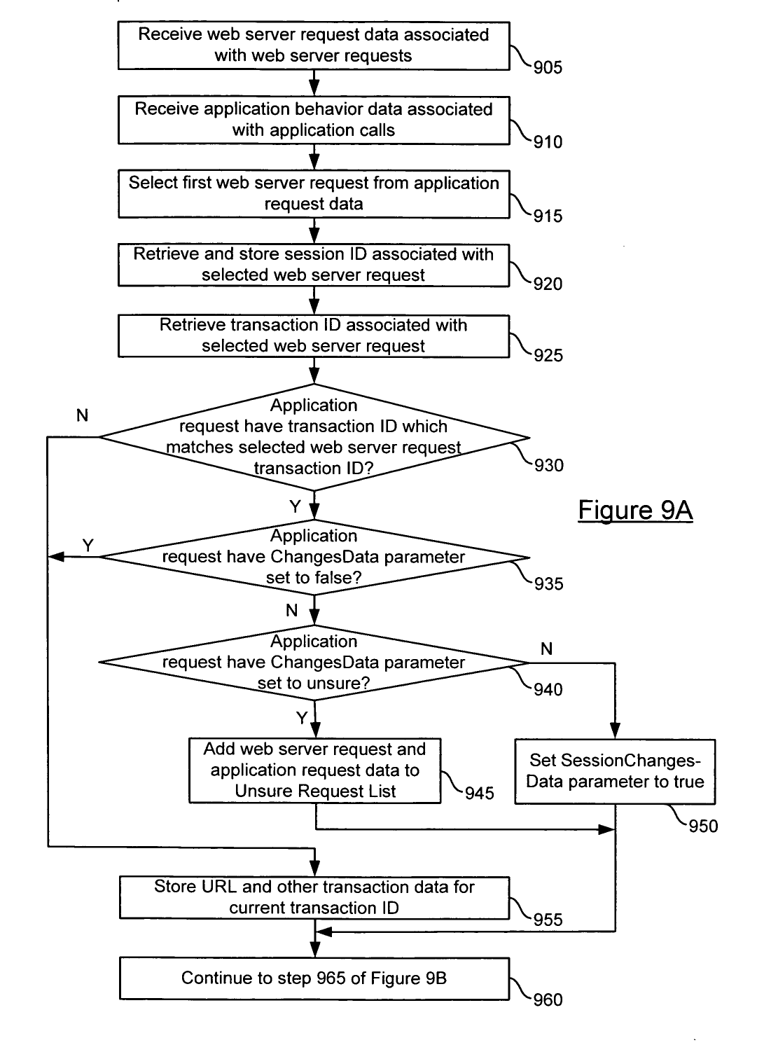

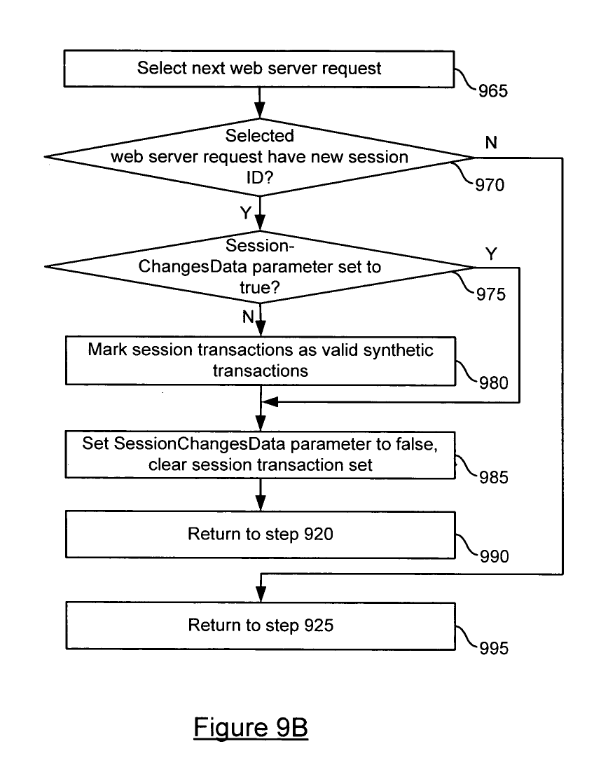

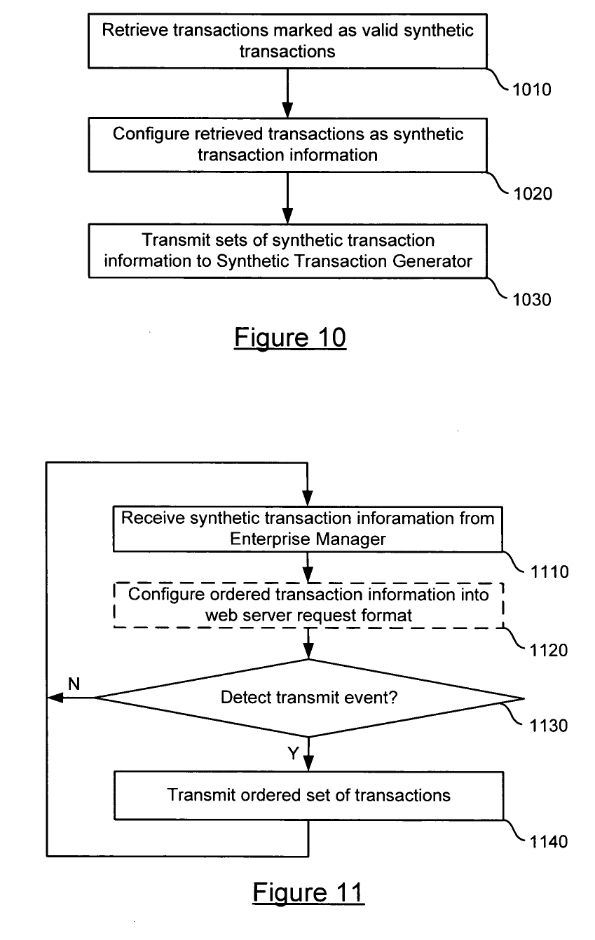

User requests are identified which would not corrupt data as a synthetic transaction at step 520. The identification is performed by Enterprise Manager 220. Identifying non-corrupting synthetic transactions is discussed in more detail below with respect to FIGS. 9A-9B. Next, synthetic transaction information is generated from the identified transactions at step 530. This is discussed in more detail below with respect to FIG. 10. After generating the synthetic transaction information, the information is provided to web server 340 at step 540. The information is provided as synthetic traffic by synthetic transaction generator 380. This is discussed in more detail below with respect to FIG. 11.

Synthetic transactions are generated from live traffic received by a web service. FIG. 6 is a flowchart of an embodiment of a process for receiving user requests sent to a web service. In one embodiment, FIG. 6 provides more detail for step 515 of FIG. 5. Steps 610-630 of the flowchart of FIG. 6 are performed by tap device 330. First, user requests are received at network tap device 330 at step 610. In one embodiment, responses to user requests are also received by tap device 330. A copy of the request (or response) is sent to URL collector 360 by tap device 330 at step 620. As discussed above, the request and/or response are forwarded to URL collector 360 as a TCP/IP data stream. After forwarding the data stream to URL collector 360, tap device 330 forwards received requests to web server 340 at step 630. In the case of a received response, tap device 330 forwards the response received from web server 340 to the requesting client device 310.

Steps 640-660 of the flowchart of FIG. 6 are performed by URL collector 360. The intercepted user request (or response) is received by URL collector 360 at step 640. The URL collector retrieves the URL, transaction identifier and session identifier from the request at step 650. As discussed above, a transaction identifier may be retrieved from a response and associated with a corresponding request URL. The session identifier is used by the URL collector along with the order in which things are seen to re-create a session (i.e. a sequence of transactions by a specific user). In some embodiments, the session identifier is unique for each user session. A user session may be comprised of a number of requests and responses while a user is logged into a web server, while a user is using a service provided by a web server, or is associated with some other group of ordered transactions for a particular user.

In one embodiment, URL collector 360 receives the request in TCP/IP format. URL collector 360 then reconstructs an HTTP request from the TCP/IP data stream received from tap device 330. The URL, transaction identifier and session identifier are then retrieved from the generated request. Other request data may also be received from the request. This may include request parameters and other data which would be required in order to generate a synthetic transaction which mimics the received request. In some embodiments, URL collector 360 may not forward all outgoing traffic for web server 340 to Enterprise Manager 220. For instance, URL locator 360 may not forward responses generated by web server 340 and sent to requesting client device 310. After retrieving requested data from the request, URL collector 360 sends the retrieved data to Enterprise Manager 220 at step 660.

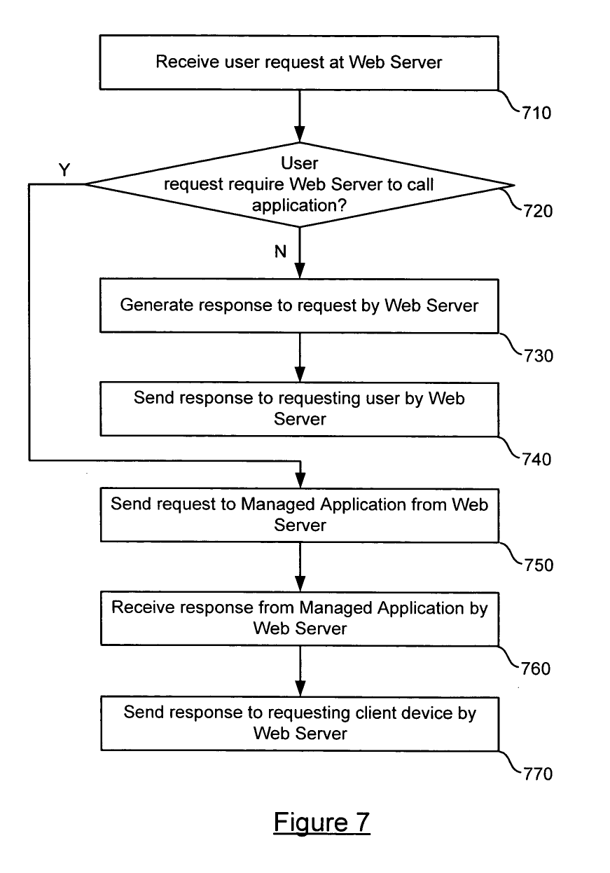

After intercepting traffic sent to web server 340, tap device 330 forwards the traffic to web server 340. FIG. 7 is a flowchart of an embodiment of a process for processing a request by web server 340. In one embodiment, the flowchart of FIG. 7 details a process performed by web server 340 in response to receiving a request from tap device 330 as discussed above at step 630 of FIG. 6. First, the user request is received at web server 340 at step 710. Next, a determination is made as to whether the user request requires web server 340 to place one or more calls to application server 130 at step 720. In this step, a determination is made as to whether a service provided by application server 210 is required to complete the request received by web server 340. If the user request requires web server 340 to make a request to application server 210, the flowchart of FIG. 7 continues to step 750. If a request to application server 210 is not required, the flowchart of FIG. 7 continues to step 730.

Web server 340 generates a response to the request at step 730. In this case, a user may be requesting a web page or other content not requiring a request to application server 210. Since application server 210 is not used to complete the request, application server 210 does not change data or write data to itself or backend server 350 or otherwise undergo a state change in response to the user request. Thus, the request can potentially be used as a synthetic transaction. This is discussed in more detail below. Once the response is generated by web server 340, the response is sent to the requesting client device 310 at step 740.

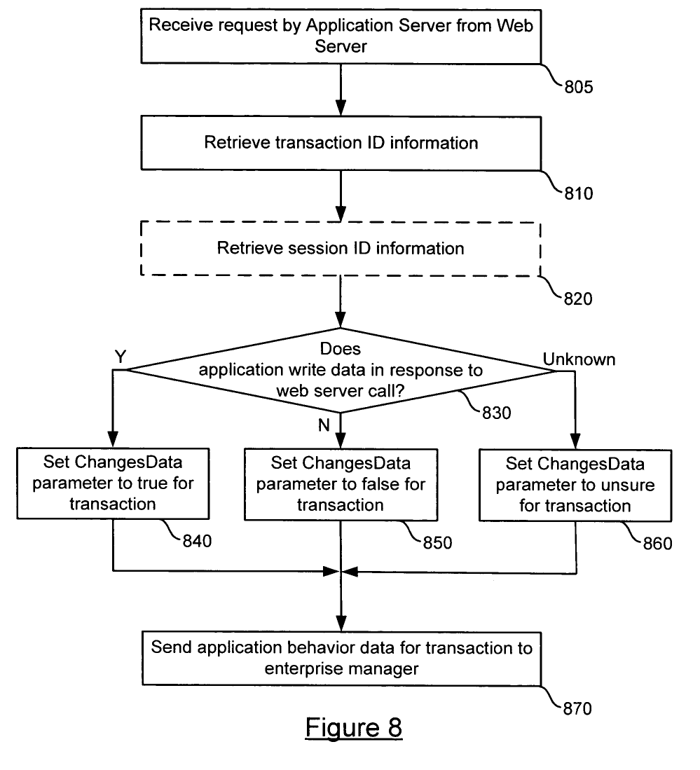

If the user request requires web server 340 to send a request to application server 210, the request is sent by web server 340 at step 750. The request made to application server 210 is made in response to the request received from a user. Next, a response is received by web server 340 from application server 210 at step 760. In this case, application server 210 receives the request, generates a response and sends the response to web server 340. While the application server processes the request from web server 340, agent 140 determines if application server 210 changes or writes data to itself or backend server 350 or otherwise changes in state in response to the request. This is discussed in more detail below with respect to FIG. 8. After receiving a response from application server 210, web server 340 sends a response to client device 310 at step 770. The response provided to the user by web server 340 is generated from the response received by web server 340 from application server 210.

FIG. 8 is a flowchart of an embodiment of a process for processing a request by a monitored application. The flowchart of FIG. 8 provides more detail for step 515 of FIG. 5 and is performed by application server 130. In one embodiment, the flowchart of FIG. 8 is performed by agent 140 which resides in application server 130. In any case, the flowchart of FIG. 8 is performed in response to receiving a request from web server 340 as discussed above at step 750 of FIG. 7. First, a request is received from web server 340 by application server 210 at step 805. In one embodiment, the request is routed to managed application 130 by application server 210. Next, transaction identifier information is retrieved from the request by managed application 130 at step 810. In one embodiment, the transaction identifier is unique for each request. Next, a session identifier is retrieved from the received request at step 820. In one embodiment, retrieving session identifier information from the received request at step 820 is optional. The information may also be retrieved by URL collector 360.

After retrieving a session identifier from the request received by managed application 130, a determination is made as to whether the application server 130 writes data in response to the web server request at step 830. In one embodiment, the determination at step 830 identifies whether managed application 130 writes data or changes data to itself or backend server 350 or otherwise experiences a changed state in response to the request received from web server 340. In one embodiment, code is inserted into objects and other code modules within managed application 130 which write data, change data or otherwise change the state of application server 130 in some way. Thus, when one of the objects is called and executed, the inserted code is executed. When executed, the performance monitoring code reports the object call to agent 140. If a determination is made that the application writes data in response to the web server request at step 830, the flowchart of FIG. 8 continues to step 840. If a determination is made that the application does not write data at step 830, the flowchart of FIG. 8 continues to step 850. If it is unknown whether application server 130 writes data in response to the web server request received, the flowchart of FIG. 8 continues to step 860.

At step 860, a Changes Data parameter associated with the request is set to unsure. The flowchart of FIG. 8 then continues to step 870. If the application does not write data, the Changes Data parameter is set to true for the transaction at step 840 and the flowchart continues to step 870. If application server 130 does write data in response to the web server request, the Changes Data parameter is set to false for the transaction at step 850 and the flowchart continues to step 870. The application server behavior data for the particular transaction is sent to Enterprise Manager 220 at step 870. The application behavior data may include the Changes Data parameter, transaction identifier information, session identifier information and optionally other information. In one embodiment, the application server behavior data is sent by agent 140 on application server 210.

FIGS. 9A-9B are flowcharts of an embodiment of a process for generating synthetic transaction information. The flowcharts provided in FIGS. 9A-9B are intended to be continuous and part of the one process. In one embodiment, the flowcharts provided in FIGS. 9A-9B provide more detail for steps 520 of the flowchart of FIG. 5 discussed above. Web server request data is received at step 905. The web server request data is received by Enterprise Manager 220 from URL collector 360. Next, application server behavior data associated with application requests is received by Enterprise Manager 220 at step 910. The application behavior data is received from agent 140 on application server 130.

The first web server request is selected from the web server request data at step 915. The session identifier associated with the selected web server request is retrieved from the request data and stored at step 920. The session identifier will be recalled for processing later in the flowchart. After storing the session ID, the transaction identifier associated with the selected web server request is retrieved at step 925. A determination is then made as to whether any application requests have a transaction identifier which matches the selected web server transaction identifier at step 930. The application behavior data contains data for the application calls. For the determination at step 930, the behavior data is checked to determine if an application request exists with a similar transaction identifier as the selected web server request. If not, the web server request did not cause web server 340 to send a request to application server 210. As a result, the web server request did not corrupt data by writing data, changing data or otherwise changing the state of application server 130. If an application request has a transaction identifier which matches the selected web server request transaction identifier at step 930, the flowchart of FIG. 9A continues to step 935. If no application calls have a matching transaction ID, the flowchart continues to step 955.

A determination is made as to whether the matching application request has a Changes Data parameter set to false at step 935. The Changes Data parameter is set at step 850 by managed application 130 in FIG. 8. If the application call has a Changes Data parameter set to false, the flowchart of FIG. 9A continues to step 955. If the application call does not have a Changes Data parameter set to false, then the flowchart continues to step 940.

A determination is made as to whether the application call has a Changes Data parameter set to unsure at step 940. If the Changes Data parameter for the application call is set to unsure, the web server request and associated application call data are added to an Unsure Request List at step 945. Web server requests and associated application call data on the Unsure Request List may be analyzed later by an administrator or automated process to determine whether the request and associated application call can be used as synthetic transactions. After adding the data to the list, the flowchart continues to step 960. If the application call does not have a Changes Data parameter set to unsure, then the Change Data parameter is set to false and the flowchart continues to step 950.

A Session Changes Data parameter is set to true at step 950. As a result, the session associated with the current transaction is determined to include at least one transaction which would corrupt data if used a synthetic transaction. Operation then continues to step 960. If at step 930 no application request transaction identifier matched the web server request identifier, the URL and other transaction data for the current transaction identifier are stored at step 955. The data and information is stored at Enterprise Manager 220 because the web server request may potentially be used as a synthetic transaction. Operation of the flowchart then continues to step 965 of FIG. 9B.

The next web server request is selected at step 965. A determination is then made as to whether the selected web server request has a new session identifier at step 970. If the selected web server request has a new session identifier (one that differs from the web server request identifier stored at step 920), the session associated with the previous transaction has ended. Determining whether the web server request has a new session identifier can be performed by comparing the session identifier of the currently selected web server request to the session identifier stored at step 920. In another embodiment, transactions for different sessions may be intermingled. In this case, detecting a new session identifier may not indicate the previous session is complete. Thus, a session may be determined to be complete after a time-out period. In other cases, a session may be determined to be complete if an end of session marker is detected for a particular application server. In this case, the end of session marker can be application server specific. Some application servers may have a known marker which need not be configured if the application server being used is communicated to the URL locator or enterprise manager. If the selected web server request has a new session ID, the flowchart continues to step 975. If the web server request does not have a new session ID, then the flowchart continues to step 995. At step 995, the flowchart returns to step 925 where the selected web server request is processed.

A determination is made at step 975 as to whether the Session Changes Data parameter is set to true at step 975. In this case, the determination is made as to whether any requests which are part of the previous session would corrupt data if used as a synthetic transaction. If the Session Changes Data parameter is set to true, the flowchart of FIG. 9B continues to step 985. If the Session Changes Data parameter is set to false, the synthetic transactions associated with the session are flagged as valid synthetic transactions at step 980. Valid synthetic transactions are eventually sent to synthetic transaction generator 380. This is discussed in more detail with respect to FIG. 11 below. In this case, the transactions associated with the previous session will not corrupt data when sent by the synthetic transaction generator 380 to web server 340. Next, the Session Changes Data parameter is reset to false and the session request data is cleared at step 985. The flowchart of FIG. 9B then returns to step 920 in the flowchart of FIG. 9A.

FIG. 10 is a flowchart of an embodiment of a process for generating synthetic transaction information. In one embodiment, the flowchart of FIG. 10 provides more detail for step 530 of the flowchart of FIG. 5. First, Enterprise Manager 220 retrieves transactions marked as valid synthetic transactions at step 1010. Transactions are marked as valid by Enterprise Manager 220 at step 980 of FIG. 9B. In some embodiments, transactions marked as valid can be associated with one or more session identifiers. In this case, one or more sets of transactions comprising one or more sessions are retrieved at step 1010.

Next, the retrieved transactions are configured as synthetic transaction information. In one embodiment, Enterprise Manager 220 packages the transactions together in a format acceptable by the particular synthetic transaction generator. The synthetic transaction information may include a list of URLs, the order that the URLs should be called, other information needed to complete the URL calls (e.g., call parameters), session information indicating what URL calls are associated with a session, and other information. After configuring the synthetic transaction information, the information is transmitted to synthetic transaction generator 380 at step 1030.

FIG. 11 is a flowchart of an embodiment of a process for providing synthetic transactions to a web service. In one embodiment, the flowchart of FIG. 11 provides more detail of step 540 of FIG. 5 discussed above. First, synthetic transaction information is received by synthetic transaction generator 380 at step 1110. The synthetic transaction information may include an ordered list of synthetic transactions and parameter information for the transactions. Next, the ordered transaction information can be configured into web server request format at step 1120. In one embodiment, this may include placing transaction information into a configuration file containing URLs to send to web server 340. Configuring the transaction information may also include constructing the actual URL call, including the call parameters, which will be sent to web server 340. In one embodiment, step 1120 is optional as indicated by the dashed line comprising the step in FIG. 11. Step 1120 may be optional because no configuration may be necessary to prepare the information to be sent to web server 340.

Next, a determination is made as to whether a transmit event is detected at step 1130. Synthetic transaction generator 360 sends synthetic traffic to web server 340 (or some other location as discussed above) in response to detecting the event. The transmit event triggers synthetic transactions to be sent to web server 340. The event may occur in response to an administrator request, a timer, or some other event. For example, a timer at which to send synthetic transactions may be set to expire every five seconds. If no transmit event is detected, the flowchart of FIG. 11 returns to step 1110.

If a transmit event is detected at step 1130, the ordered set of transactions is transmitted to web server 340 at step 1140. The transactions are typically sent one at a time to web server 340. In one embodiment, the transactions are a series of requests. In this case, the first of the ordered requests is sent first. In some embodiments, the second transaction in the ordered set may be sent after a response to the first request is received from web server 340. The response may indicate that the server has completed processing the first request, may include information needed for the second request or provide other information. Once the response is received, the second transaction in the ordered set is sent to web server 340. In one embodiment, tap device 330 may intercept the synthetic transactions sent by synthetic transaction generator 380. This is indicated by the dashed line from synthetic transaction generator 380 to tap device 330. Once the ordered sets of transactions are transmitted, the flowchart of FIG. 11 returns to step 1110.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for configuring synthetic transactions, comprising:
intercepting web server traffic
identifying a portion of the traffic that would not corrupt data as one or more synthetic transactions; and
generating synthetic transactions based on the identified portion of the traffic.

2. The method of claim 1, wherein said step of intercepting web server traffic includes:
intercepting traffic by a tap device.

3. The method of claim 1, wherein said step of intercepting web server traffic includes
retrieving URL information from the intercepted traffic

4. The method of claim 1, wherein said step of identifying a portion of the traffic includes:
receiving application server behavior data associated with an application server; and
comparing the application server behavior data to the intercepted web server traffic.

5. The method of claim 1, wherein said step of identifying a portion of the traffic includes:
identifying web server traffic that is not processed by the application server.

6. The method of claim 1, wherein said step of identifying a portion of the traffic includes:
identifying traffic that initiates an application server to change data.

7. The method of claim 1, wherein said step of generating synthetic transactions includes:
configuring a list of URLs to call.

8. The method of claim 1, wherein said step of generating synthetic transactions includes:
generating an ordered list of requests to send to a web server.

9. The method of claim 1, further comprising:
providing the synthetic transactions to a synthetic transaction generator.

10. One or more processor readable storage devices having processor readable code embodied on said processor readable storage devices, said processor readable code for programming one or more processors to perform a method comprising:
capturing web service request data associated with web server traffic received by a web server;
comparing the web service traffic information to application server behavior data; and
identifying web server traffic which does not cause data corruption associated with the application server.

11. The one or more processor readable storage devices of claim 10, wherein said step of capturing web service request data includes:
intercepting web service traffic; and
identifying web server requests in the web service traffic.

12. The one or more processor readable storage devices of claim 10, wherein said step of capturing web service request data includes:
receiving a data stream from an interceptor machine;
retrieving request data from the data stream.

13. The one or more processor readable storage devices of claim 10, wherein the web service request data includes a URL data associated with a request.

14. The one or more processor readable storage devices of claim 10, wherein the web service request data includes transaction identifier information.

15. The one or more processor readable storage devices of claim 10, wherein said step of comparing includes:
determining the web server traffic information includes a first transaction identifier that matches a second transaction identifier within the application server behavior data.

16. The one or more processor readable storage devices of claim 15, wherein said step of comparing includes:
determining that the matching second transaction identifier within the application server behavior data is associated with a transaction that writes data to an application server.

17. The one or more processor readable storage devices of claim 10, wherein said step of identifying web server traffic includes:
identifying requests received by the web server which do not change data in an application server.

18. The one or more processor readable storage devices of claim 10, wherein said step of identifying web server traffic includes:
identifying a set of transactions associated with a session identifier, wherein each transaction in the set of transactions is determined to not corrupt data.

19. An apparatus for processing data, comprising:
a communication interface;
a storage device; and
one or more processors in communication with said storage device and said communication interface, said one or more processors perform a method comprising:
inserting executable code into a managed application;
receiving a request which results in corruption of data by the managed application; and
reporting request information associated with the request by the executable code.

20. The apparatus of claim 19, wherein said step of receiving a request includes:
receiving a request which changes the state of an application server which contains the managed application.

21. The apparatus of claim 19, wherein said step of receiving a request includes:
receiving a request from a web server associated with a request received by the web server.

22. The apparatus of claim 19, wherein said step of receiving a request includes:
setting a parameter associated with the request to indicate the request corrupts data.

23. The apparatus of claim 19, wherein said step of reporting request information includes:
reporting a transaction identifier and a data parameter, the data parameter indicating whether the request corrupts data.

24. The apparatus of claim 19, wherein said step of reporting request information includes:
retrieving a set of application server behavior data for a set of transactions; and
sending the set of application server behavior data.

25. A method of configuring synthetic transactions, comprising:
receiving transaction data for a web service, the web service associated with web server and an application server;
processing the transaction data to identify transactions which do no change the state of the application server; and
generating synthetic transactions from the identified transactions which do not corrupt data.

26. The method of claim 25, wherein said step of receiving transaction data includes:
receiving traffic data associated with the web server.

27. The method of claim 26, wherein the traffic data includes a set of URLs and a transaction identifier for each URL.

28. The method of claim 25, wherein said step of receiving transaction data includes:
receiving application server data from the application server.

29. The method of claim 28, wherein the application server data includes a set of transaction identifiers and a behavior parameter, the behavior parameter indicating whether a transaction associated with each transaction identifier corrupts data.

30. The method of claim 25, wherein said step of processing the transaction data includes:
detecting requests for a web server that are not associated with application server behavior data.

31. The method of claim 25, wherein said step of processing the transaction data includes:
detecting requests for a web server that are associated with application server requests which do not change the state of the application server.

32. The method of claim 31, wherein said step of processing the transaction data includes:
identifying a set of URLs associated with the detected requests.

33. The method of claim 25, wherein said step of generating synthetic transactions includes:
generating a list of URLs associated with identified transactions which do not change the state of the application server.

34. The method of claim 33, wherein the list of URLs is an ordered list.

35. The method of claim 25, wherein said step of generating synthetic transactions includes:
creating a list of URLs;
configuring URL parameters for at least one of the listed URLs.

36. The method of claim 25, further comprising:
transmitting the synthetic transactions to synthetic transaction generator.

37. A method for creating synthetic transactions, comprising:
inserting monitoring code in an application to retrieve application behavior data;
identifying data corruption information using the monitoring code and a web server traffic interceptor; and
creating synthetic transactions from the data corruption information.

38. The method of claim 37, wherein the data corruption information includes identification information for transactions which do not corrupt data.

39. The method of claim 38, wherein the identification information identifies transactions received by a web server.

40. The method of claim 37, wherein said step of identifying data corruption information includes receiving data streams from an application server a URL detector, the URL detector receiving network traffic data from the web server traffic interceptor.

41. A method for constructing synthetic transactions, comprising:
receiving intercepted network traffic information for a web service;
receiving behavior data indicative of performance of an application;
constructing synthetic transactions from the intercepted network traffic information associated with the web server and the behavior data.

42. The method of claim 41, wherein the intercepted network traffic information includes a URL address for each request received by the web service.

43. The method of claim 41, wherein the behavior data includes information indicating whether the application corrupts based on a web service request.

44. The method of claim 41 , wherein said step of constructing synthetic transactions includes:
comparing the intercepted network traffic information associated with the web server and the behavior data
